(19) United States
(12) Patent Application Publication
(10) Pub. No.: US 2019/0156329 A1
(43) Pub. Date: May 23, 2019

(54) MOBILE PHONE PREPAID CARD SERVICE SYSTEM, CLONE CARD STORAGE DEVICE THEREOF, AND SERVICE METHOD

(71) Applicant: KONA I CO., LTD., Seoul (KR)

(72) Inventors: Ki Yeon LEE, Seoul (KR); Wan Jae LEE, Seoul (KR); So Young JUNG, Seoul (KR)

(21) Appl. No.: 16/097,542

(22) PCT Filed: Apr. 29, 2016
(86) PCT No.: PCT/KR2016/004555

§ 371 Date: Oct. 29, 2018

(30) Foreign Application Priority Data
Apr. 28, 2016 (KR) 10-2016-0052019
Apr. 28, 2016 (KR) 10-2016-0052028

(51) Int. Cl. G06Q 20/34; G06Q 20/08; G06Q 20/28

(52) U.S. Cl. CPC G06Q 20/342; G06Q 20/28; G06Q 20/085

(57) ABSTRACT

The present disclosure relates to a mobile phone prepaid card service system, a clone card storage device thereof, and a service method. The prepaid card service system according to the present disclosure comprises: a prepaid card company server for issuing a mobile phone prepaid card, which can be used for the amount of money added thereto; and a prepaid card wallet application stored in a storage space of a terminal of a user using the mobile phone prepaid card and executed thereon, and storing the mobile phone prepaid card, wherein the mobile phone prepaid card comprises a default card connected to a user account stored in the prepaid card company server, and at least one option card, which is distinct from the default card and has at least one additional function.

### TECHNICAL FIELD

The present disclosure relates to a service system of a mobile prepaid card, and a clone card storage device and a service method of the mobile prepaid card, and more specifically, to a service system of a mobile prepaid card, and a clone card storage device and a service method of the mobile prepaid card, which can be applied to various payment environments such as online, offline and mobile environments.

### BACKGROUND ART

Recently, the problem of forgery of magnetic stripe cards, which are commonly used in direct payment or prepaid card transactions, becomes serious. As a means for solving the problem, EMV (an IC card standard specification developed by three companies of Europay, Master Card and VISA) card service based on smart card is provided, and it is currently tried in Korea to reduce the problems caused by forgery of the magnetic stripe cards by replacing existing merchant terminals for recognizing magnetic cards with IC card terminals.

In a different aspect, there is provided a service like Samsung Pay, which registers cards issued through existing affiliate card companies in Samsung Pay application and make payments using the registered information.

However, since the conventional credit or prepaid card services like this provide services based on physically issued cards, the card service is not provided until a physical real card is issued, and it is frequent that the issuance is delayed.

Offline gift certificates are limited in that they can be used only at an issuer company or affiliated companies having a particular relationship with the issuer company, and although prepaid cards are not limited in the place of using the prepaid cards like cash, there is an inconvenience in that a user should receive a prepaid card from a bank or the like after linking a user's account or opening a new account.

As another concept, there are unregistered gift cards. A user may purchase a gift card by paying a face value to the issuer and give it to others as a gift, and a person receiving the gift card is not limited in using the gift card.

Although the gift cards can be used like cash within a predetermined amount, it is difficult to handle the balance after using the cards, and the gift cards should be purchased offline.

The Korean Laid-opened Patent No. 10-2002-0074105 (Method of operating gift card certificate on the basis of credit card system) discloses a technique of getting and using a card certificate on the basis of a credit card by an existing credit card user. However, there is a problem in that the procedure of getting a card certificate is also not easy, and it is difficult to give the card certificate to other people as a gift.

In addition, mobile gift certificates currently in use will remain in a one-time relationship between the issuer and the user of the mobile gift certificates. This is since that most of the mobile gift certificates can be exchanged with specific products and there is no link for using the issuer's products again after using the mobile gift certificates, and from the viewpoint of issuers, there are difficulties in maintaining and managing customers.

In addition, conventionally, it inconvenient in that credit or prepaid cards stored in a smart device such as a smart phone or the like can be used only when the smart device is carried.

### DISCLOSURE OF INVENTION

### Technical Problem

Therefore, the present disclosure has been made in view of the above problems, and it is an object of the present disclosure to provide an integrated mobile prepaid card service system, in which a mobile prepaid card can be freely used for offline payment, as well as online or mobile payment.

For this purpose, the present disclosure provides a service system of a mobile prepaid card, a clone card storage device and a service method thereof, in which a mobile prepaid card user may receive a clone card of the mobile prepaid card and store and use the clone card in a tangible card that can be used for offline payment.

### Technical Solution

A clone card of a mobile prepaid card according to one aspect of the present disclosure for accomplishing the above objects may be generated by a user terminal in a method of copying the mobile prepaid card stored in a prepaid card wallet application. The clone card is stored in a tangible card and can be used as an offline payment means, independently of the mobile prepaid card.

According to embodiments, the tangible card may include an external secure element (SE) storage device, such as a card SE or a wearable device.

According to embodiments, the card SE is an IC card or a combination card, and the wearable device may include a smart watch, a smart band and smart glasses.

A prepaid card wallet application according to another aspect of the present disclosure may be stored and executed in a storage space of a user terminal, and may perform a function as the user terminal is connected to the prepaid card company server through communication. The prepaid card wallet application may provide prepaid card service using one or more mobile prepaid cards stored in the user terminal, request the prepaid card company server issuance of a clone card for the mobile prepaid card, and include a card export module for transmitting the issued clone card to a tangible card for offline payment.

A prepaid card wallet application according to still another aspect of the present disclosure is connected to the prepaid card company server through communication, provides prepaid card service using one or more mobile prepaid cards stored in the user terminal, issues a clone card for the mobile prepaid card, transmits the clone card to a tangible card for offline payment, and includes a card export module for notifying issuance of the clone card to the prepaid card company server.

In an embodiment, the prepaid card wallet application may further include a card import module for reading information on the clone card and generating the mobile prepaid card.

In an embodiment, the card export module may perform a charged amount transfer operation of transferring some or all of a charged amount of the mobile prepaid card to the clone card.

In an embodiment, the card import module may perform a charged amount transfer operation of transferring some or all of a charged amount of the clone card to the mobile prepaid card.

A prepaid card service system according to still another aspect of the present disclosure includes: a token service module connected to a user terminal in which a prepaid card wallet application is installed through communication to issue a clone card of a mobile prepaid card, and confirm, if a token requesting issuance of a clone card of the mobile prepaid card is received from the user terminal, basic account information of the mobile prepaid card in the token; and a clone card issuance server for issuing a clone card for the mobile prepaid card, wherein the token service module registers the clone card in the basic account information of the mobile prepaid card.

In an embodiment, the token service module may register the clone card to have a unique identification value different from that of a previously registered mobile prepaid card.

A prepaid card service system according to still another aspect of the present disclosure provides a service using a prepaid card and may include: a prepaid card company server for issuing a mobile prepaid card that can be used within a charged amount; and a prepaid card wallet application stored and executed in a storage space of a user terminal—the user uses mobile prepaid card-, and storing the mobile prepaid card. The mobile prepaid card may include: a basic card associated with a user account stored in the prepaid card company server; and at least one or more option cards distinguished from the basic card and provided with at least one or more additional functions.

In an embodiment, the option card may be assigned with a separate use amount within a charged amount of the basic card according to a selection received from the user terminal.

In an embodiment, the prepaid card wallet application may include a balance collection module for adding charged amounts of the at least one or more option cards as a charged amount of the basic card. For example, the balance collection module is executed when the balance of an option card is lower than a preset ratio with respect to an initially charged amount or less than a minimum amount for providing the additional function, and adds the balance to the charged amount of the basic card.

In an embodiment, the prepaid card wallet application may include a card export module for transferring the basic card or the option card to a tangible card. For example, the tangible card may include a storage device for storing card information in an external secure element (SE) such as a card SE or a wearable device. The prepaid card wallet application may further include a card import module for reading information on the tangible card and transfer the tangible card information to the basic card or the option card, which are mobile prepaid cards. In addition, the card export module may transmit information on the mobile prepaid card and all of the charged amount of the mobile prepaid card to the tangible card, and delete the information on the mobile prepaid card transferred from the user terminal. The card export module may copy information on the mobile prepaid card and some or all of the charged amount of the mobile prepaid card to the tangible card, and the prepaid card company server may manage clone card information copied to the tangible card, using a primary account number (PAN) the same that of the mobile prepaid card associated with the user account.

In an embodiment, the mobile prepaid card may be stored in the user terminal in the form of a token value, and the prepaid card company server may include information on the token value mapped to information on the tangible card of the mobile prepaid card. The prepaid card service system according to an embodiment of the present disclosure may further include a clone card issuance server for issuing a new token value generated according to a predefined algorithm to the user terminal when the token value stored in the user terminal is exhausted.

A clone card storage device according to an embodiment of the present disclosure may include a secure element (SE) for storing information on the mobile prepaid card, which is stored in advance in a prepaid card wallet application stored and executed in a storage space of a user terminal, copied and transferred as clone card information in response to tagging the mobile prepaid card to the user terminal within a preset distance. The clone card information may be used as a payment means, independently of the mobile prepaid card. For example, the secure element may include a card SE or an SE mounted on a wearable device.

According to embodiments, the clone card information may include card information of the mobile prepaid card and some or all of a charged amount of the mobile prepaid card.

According to embodiments, the clone card information may have primary account number (PAN) information the same as that of the mobile prepaid card and a different device identification number (e.g., PSN). In addition, the clone card information may be managed by the prepaid card company server using the PAN information the same as that of the mobile prepaid card.

In an embodiment, the prepaid card wallet application may generate a mobile prepaid card by copying the clone card.

In an embodiment, the prepaid card wallet application may request the prepaid card company server issuance of a clone card for the mobile prepaid card, and further include a card export module for transmitting the issued clone card to a tangible card for offline payment.

In an embodiment, the prepaid card wallet application may issue a clone card for the mobile prepaid card, transmit the clone card to a tangible card for offline payment, and include a card export module for notifying issuance of the clone card to the prepaid card company server.

In an embodiment, the prepaid card company server may issue the clone card to share the primary account number of the mobile card.

In an embodiment, the tangible card is preferably an external SE storage device such as a card SE or a wearable device.

In an embodiment, the mobile prepaid card may include a basic card that can be used within the limit of an amount charged in the user account, and an option card linked to or separate from the basic card and has a use limit set by the user within a range of an amount charged in the user account.

A clone card service method according to still another aspect of the present disclosure may include the steps of: a) transferring a request for issuing a clone card for a mobile prepaid card to a prepaid card company server, by a user terminal which stores the mobile prepaid card; b) confirming account information for the mobile prepaid card, and requesting a clone card issuance server to issue a clone card, by the prepaid card company server; c) connecting to a card storage device through the user terminal, by the clone card issuance server; and d) issuing a clone card corresponding to the mobile prepaid card to the card storage device, by the clone card issuance server.

According to embodiments, the clone card service method according to an embodiment of the present disclosure may further include the step of registering the clone card in the account information, by the prepaid card company server. For example, the step of registering the clone card includes the step of registering the clone card in the account information using PAN information the same as that of the mobile prepaid card.

In an embodiment, the prepaid card company server may include a ledger management server for managing a balance of a card, and when the ledger management server manages balances of the mobile prepaid card and the clone card, the ledger management server may process the mobile prepaid card and the clone card to have the same balance information according to the same PAN information.

According to embodiments, the prepaid card company server may process to automatically synchronize the balances of the mobile prepaid card and the clone card when the balance information is updated.

### Advantageous Effects

According to a device for storing a clone card of a mobile prepaid card, a clone card service method and a prepaid card service system according to the embodiments of the present disclosure, a user may easily get a mobile prepaid card, and information on the clone card may be stored in a tangible card and used for offline payment. Accordingly, the user of the mobile prepaid card can be provided with prepaid card service through the clone card information stored in the tangible card even in an offline environment. In addition, a holder of the clone card can be provided with prepaid card service the same as that of the mobile prepaid card without a terminal in which the mobile prepaid card is stored.

Therefore, according to the embodiments of the present disclosure, when a clone card storage device of a mobile prepaid card, a clone card service method and a prepaid card service system are used, the environment of using the mobile prepaid card is not limited to an online or mobile environment, but can be extended to an offline environment. Accordingly, a user of the clone card of a mobile prepaid card of the present disclosure can be provided with an integrated online, mobile and offline prepaid card service.

In addition, according to the embodiments of the present disclosure, when a storage device, a clone card service method and a prepaid card service system are used, a user of a mobile prepaid card can be directly issued with a clone card of the mobile prepaid card through a user terminal, and the issued clone card may be directly transferred to a tangible card desired to be used, by the user through a short distance wireless communication method, to be used as a tangible card. Accordingly, a clone card of a mobile prepaid card of the present disclosure can be safely and conveniently issued.

According to various embodiments of the present disclosure, since a user himself or herself may issue a clone card that can be used in an offline environment, issuance of a prepaid card for commencing offline use, such as a paper gift certificate, a plastic gift certificate, etc., is unnecessary. Therefore, when the prepaid card service system of the present disclosure is used, an affiliate company may reduce cost for issuance of prepaid cards such as paper gift certificates, plastic gift certificates, etc., as well as franchise fees. In addition, therefore, although the affiliate company does not separately construct a service platform of its own, it is easy to issue a mobile affiliate card and a clone card thereof.

In addition, since the mobile prepaid card of the present disclosure is able to complete a payment using a clone card, card information such as a primary account number (PAN) is not exposed in a communication process, and thus a safe payment environment can be achieved.

In addition, since the mobile prepaid card of the present disclosure uses a clone card, a prepaid card service can be provided without intervention of a mobile communication company or a financial company, and thus a payment platform can be easily constructed.

### BRIEF DESCRIPTION OF THE DRAWINGS

FIG. 1 is a diagram illustrating a configuration of a prepaid card service system for providing prepaid card service according to an embodiment of the present disclosure.

FIG. 2 is a diagram schematically illustrating a process of issuing a basic card included in mobile prepaid cards in the present disclosure.

FIG. 3 is a diagram illustrating a process of issuing a clone card of a mobile prepaid card stored in a user terminal.

FIG. 4 is a block diagram illustrating an embodiment of a prepaid card wallet application installed on a user terminal.

FIG. 5 is a block diagram illustrating an embodiment of a prepaid card company server.

FIGS. 6 and 7 are diagrams illustrating embodiments of a process of making a payment using a user terminal in which a mobile prepaid card is stored or a tangible card in which a clone card is stored.

FIG. 8 is a conceptual diagram illustrating a user receiving a mobile prepaid card service using a user terminal and a tangible card.

FIG. 9 is a diagram illustrating an embodiment of a process of issuing an affiliate card as an option card.

FIG. 10 is a diagram illustrating an exemplary embodiment of a prepaid card wallet application screen of a user terminal.

FIG. 11 is a diagram illustrating a screen of an exemplary embodiment in which an option card is given to a gift receiving terminal as a gift in a user terminal.

FIG. 12 is diagram illustrating an exemplary embodiment of a gift box screen of a card management module of a prepaid card wallet application.

FIGS. 13 and 14 are diagrams respectively illustrating an exemplary example screen of an application for describing a method of processing a card balance using the present disclosure.

### BEST MODE FOR CARRYING OUT THE INVENTION

As the present disclosure allows for various changes and numerous embodiments, particular embodiments will be illustrated in the drawings and described in detail in the written description. However, this is not intended to limit the present disclosure to particular modes of practice, and it is to be appreciated that all changes, equivalents, and substitutes that do not depart from the spirit and technical scope of the present disclosure are encompassed in the present disclosure.

It will be understood that, although the terms including ordinal numbers such as first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

The terms used in the embodiments of the present disclosure are for the purpose of describing particular embodiments only and is not intended to be limiting of example embodiments. As used herein, the singular forms are intended to include the plural forms as well, unless the context clearly indicates otherwise. It will be further understood that the terms “comprises”, “comprising,”, “includes” and/or “including”, when used in the embodiments of the present disclosure, specify the presence of stated features, integers, steps, operations, elements, and/or components, but do not preclude the presence or addition of one or more other features, integers, steps, operations, elements, components, and/or groups thereof.

Unless otherwise defined, all terms used herein, including technical or scientific terms, have the same meanings as those generally understood by those with ordinary knowledge in the field of art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present application.

A clone card of a mobile prepaid card of the present disclosure and a method of issuing the same, and a prepaid card service system including the clone card of the mobile prepaid card and a service method thereof will be described below in detail with reference to the accompanying drawings.

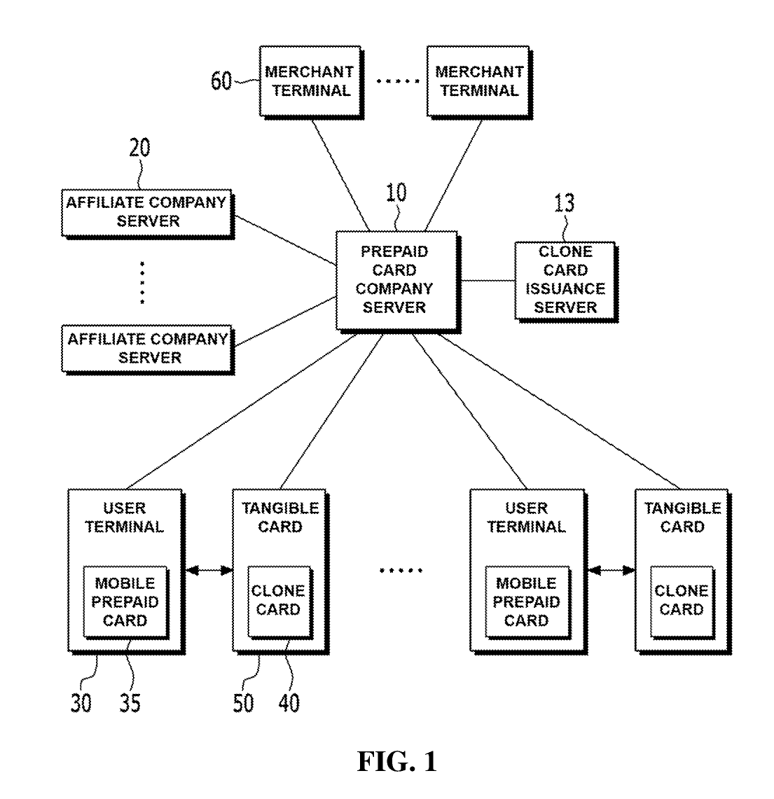

FIG. 1 is a diagram illustrating a configuration of a prepaid card service system for providing prepaid card service according to an exemplary embodiment of the present disclosure.

Referring to FIG. 1, a prepaid card service system according to an exemplary embodiment of the present disclosure includes: a prepaid card company server 10 for opening a prepaid card account in response to a request of a member user, issuing a mobile prepaid card 35 that can be used within an amount charged in the prepaid card account, and issuing and managing a clone card 40 of the mobile prepaid card 35, together with a clone card issuance server 13, in response to a request; a plurality of user terminals 30 for storing and using the mobile prepaid card 35 issued by the prepaid card company server 10, requesting the prepaid card company server 10 issuance of the clone card 40 of the mobile prepaid card 35 as needed, and transmitting the issued clone card 40 to a certain tangible card 50; and a plurality of merchant terminals 60 that can use the prepaid card of the user terminal 30 as a payment means. In addition, a clone card service system of the mobile prepaid card 35 of this embodiment may further include an affiliate company server 20 for issuing an affiliate card as an option card, included in the prepaid cards issued by the prepaid card company server 10, in partnership with the prepaid card company server 10.

In the present disclosure, the user terminal 30 may request issuance of a clone card for each of one or more mobile prepaid cards 35. In this case, the prepaid card company server 10 sequentially or simultaneously issues clone cards for the mobile prepaid cards 35, together with the clone card issuance server 13, and transmits the clone card to the user terminal 30. The user terminal 30 operates, as a prepaid card application for storing the mobile prepaid cards is stored and executed in a storage space of the user terminal 30.

The clone card issuance server 13 may include a Trusted Service Manager (TSM). The clone card issuance server 13 may receive a clone card issuance request from the prepaid card company server 10 and issue a clone card in the secure element (SE) of the tangible card. Card information stored in the SE of the tangible card may be a token value. In the procedure of issuing the clone card through the clone card issuance server 13, the user terminal 30 functions as a medium for transferring the clone card, together with the clone card issuance server 13. In the final procedure of issuing the clone card, a connection may be established among the clone card issuance server 13, the user terminal, and the SE of the tangible card (e.g., establishment of APDU) without intervention of the prepaid card company server 10.

The user terminal 30 to which the clone card is issued connects to a certain tangible card 50 and transmits the clone card 40, preferably using a short distance wireless communication method. In this embodiment, the connection method of the user terminal 30 and the tangible card 50 is not specially limited, and it can be accomplished through a general wired or wireless communication method. For example, the user terminal 30 and the tangible card 50 may be connected each other and transmit the clone card 40 through a short distance wireless communication method, preferably near field communication (NFC). The tangible card 50 may correspond to a storage device which can store clone card information generated according to an exemplary embodiment of the present disclosure.

The tangible card 50, in which the clone card 40 transmitted and stored, performs a predetermined prepaid card service, independently of the mobile prepaid card 35, which is a parent card thereof.

In this embodiment, the tangible card may store one or more clone cards, and if a configuration has an entity that can be used offline, it is not particularly limited. For example, the tangible card for storing the clone card may include an external SE storage device, such as a card SE or a wearable device.

Here, the card SE may include a smart card such as an IC card, a combination card or the like, and the wearable device may include a smart watch, a smart band or smart glasses.

In this embodiment, the tangible card includes a card storage unit for storing a clone card transmitted from the user terminal, and a plurality of clone cards can be stored in the tangible card. In this specification, when one clone card is stored in the tangible card, the tangible card and the clone card may be regarded as objects of the same concept, and a tangible card may be referred to as a clone card in some cases.

Contrarily, when two or more clone cards are stored in the tangible card, particularly, when the tangible card is a combination card, each of the clone cards may be implemented in the form of an applet and stored in the tangible card.

According to embodiments, when two or more clone cards are stored in the tangible card, the tangible card of the present disclosure may further include a clone card selection module for selecting a clone card to be used among the two or more clone cards when the tangible card is to be used as a prepaid card.

The clone card selection module may be configured to have a user interface for selecting a clone card to be used among two or more clone cards stored in the tangible card so that a clone card to be used may be selected by selection of a user. In another embodiment, it may be configured to automatically select and use a clone card that can be used at a franchise store in which the tangible card is desired to be used as a prepaid card, without separate selection of the user.

In another embodiment, when the user terminal and the tangible card are connected through communication, a clone card to be used may be selected by a card management module, which will be described below, installed on the user terminal.

In addition, in the present disclosure, the tangible card may further include, in addition to the clone card, various applets used for prepaid card service, and for example, it may receive and store various security programs used for card payment, such as an accredited certificate. When the accredited certificate is embedded on the tangible card like this, log-in or the like of the accredited certificate can be conveniently performed through the tangible card when a payment is made using a mobile prepaid card or a clone card.

Hereinafter, a clone card service system of a mobile prepaid card according to an exemplary embodiment of the present disclosure configured like this will be described in more detail.

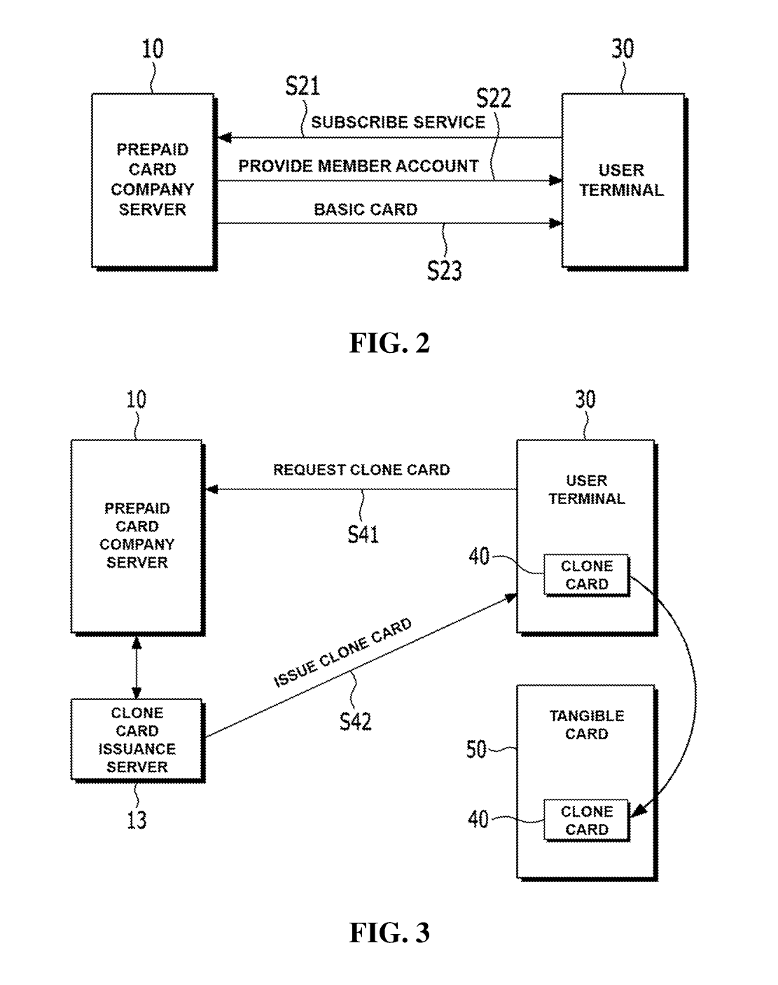

In an exemplary embodiment of the present disclosure, issuance of a prepaid card between the user terminal 30 and the prepaid card company server 10 is described with reference to FIG. 2. Although it is described in FIG. 2 focusing on the basic card among various types of mobile prepaid cards, option cards other than the basic card can be issued in the same method.

Issuance of the basic card among the mobile prepaid cards according to an embodiment of the present disclosure includes the steps of: requesting, by the user terminal 30, the prepaid card company server 10 subscription of a service (step S21); receiving a member account from the prepaid card company server 10 and registering a user account in the user terminal 30 (step S22); and receiving basic card information from the prepaid card company server 10 and issuing the basic card using a prepaid card wallet application of the user terminal 30 (step S23).

This will be described in detail hereinafter.

First, at step S21, a user subscribes a service by connecting to a webpage of the prepaid card company server 10 or executing the prepaid card wallet application using the user terminal 30. The service subscription procedure may follow a general service subscription procedure in a web environment. According to embodiments, the service subscription procedure may include an identity authentication procedure, such as cellular phone authentication, I-pin authentication or the like.

The service subscription procedure may include a terms and conditions agreement procedure for consenting to the terms and conditions of financial transactions and may also include a payment information input procedure for selecting a means for charging the user account and inputting information on a payment means as needed. Here, the user account charging means is a means for charging the account by depositing a certain amount of money into the user account and may include various account charging means such as deposit without a passbook, money transfer, credit card, debit card, small amount loan, point or mileage conversion and the like. The user account charging means charges a prepaid card that will be issued and used in the future by depositing a certain amount in the user account according to selection of the user.

According to embodiments, if a specific condition is satisfied, the basic card can be automatically charged through a predetermined user account charging means. For example, the user may set the user account charging means to automatically charge when the balance of the basic card is lower than a predetermined amount or periodically.

At step S22, the prepaid card company server 10 approves the service subscription, opens a user account for the approved user, and provides information on the user account to the user terminal 30. At this time, the user account information may be informed through an encoded e-mail account or informed to an authenticated user terminal 30 through short message service (SMS), or may be informed through other possible means such as a voice message or a notification function of a smart phone application.

The user account provided by the prepaid card company server 10 is registered in the user terminal 30, and the user of the issued user account may charge a prepaid card that will be issued later by depositing a certain amount in the user account or may use a prepaid card by depositing a certain amount in the user account after receiving the prepaid card.

Although service subscription is described in this embodiment, the prepaid card wallet application of the present disclosure does not necessarily need to subscribe a service and can be used without subscribing the service, and of course, it should be interpreted that this also falls within the scope of the present disclosure.

At step S23, after subscription of service is completed, the prepaid card company server 10 issues a mobile prepaid card.

The prepaid card may be stored in the prepaid card wallet application of the user terminal 30.

The prepaid card issued by the prepaid card company server 10 and stored in the prepaid card wallet application is conceptually classified into a basic card and an option card. The basic card is a registered or unregistered card of the user himself or herself linked to the user account, and the option card may be a registered or unregistered affiliate or non-affiliate card derived from the basic card according to a need and request of the user.

According to embodiments, the basic card is linked to the user account managed by the prepaid card company server 10, and the option card is distinguished from the basic card and may be provided with at least one additional function.

Next, in an embodiment of the present disclosure, the procedure of issuing a clone card 40 of the mobile prepaid card 35 stored in the user terminal 30 is described with reference to FIG. 3.

The user terminal 30 and the tangible card 50 are connected through wired or wireless communication to exchange information. For example, the user terminal 30 and the tangible card 50 may be connected through short distance wireless communication, and this connection may be established by tagging the previously prepared tangible card 50 to the user terminal 30. At this time, the tangible card 50 purchased by mail or at a store through a predetermined purchase procedure may be used.

The prepaid card wallet application installed in the user terminal 30 may recognize connection of the user terminal 30 and the tangible card 50 as a request for issuance of a clone card for the mobile prepaid card 35. In this case, the user terminal 30 transfers the request for issuance of a clone card of the mobile prepaid card 35 to the prepaid card company server 10 (step S41).

The prepaid card wallet application may select a mobile prepaid card 35 to be used offline if one or more mobile prepaid cards 35 are stored and request the prepaid card company server 10 issuance of a clone card of the selected mobile prepaid card 35.

If the clone card issuance request is received, the prepaid card company server 10 and the clone card issuance server 13 issue a clone card for the selected mobile prepaid card 35 and transmit the clone card to the user terminal (step S42). Although a case of issuing a clone card by the prepaid card company server 10 and the clone card issuance server 13 is described in this embodiment, according to the object, the clone card 40 may be immediately issued by the prepaid card wallet application without approval of the prepaid card company server 10. In this case, the prepaid card wallet application notifies issuance of the clone card 40 to the prepaid card company server 10.

The issued clone card may share the primary account number (a user account, PAN) of the target mobile prepaid card.

The clone card 40 transmitted to the user terminal 30 is transmitted and stored in the tangible card 50 connected in a short distance wireless communication method (step S43). Transmission of the issued clone card 40 to the tangible card 50 may be accomplished without approval of the prepaid card company server 10. Therefore, the user may freely copy and use the clone card stored in the user terminal 30 in a wearable device such as a smart watch, another smart device such as a smart pad or the like. However, even in this case, after transmission of the tangible card 50 is completed, it is preferable from the aspect of prepaid card management to notify a result of the transmission to the prepaid card company server 10.

When the clone card 40 is stored in the tangible card 50, the prepaid card company server 10 may keep the basic card and the clone card 40 continuously synchronized when a payment is made using the basic card or the clone card 40, in a method of subtracting a payment amount from a charged amount of a corresponding card among the cards linked to the user account by a ledger management server.

In this embodiment, it is preferable that the clone card 40 is issued to have the same PAN information as that of the mobile prepaid card, which is the foundation of generating the clone card 40, and have a unique identification value (PSN information) different from that of the mobile prepaid card. For example, a method of setting PSN information of the clone card 40 as PSN#2 if PSN information of the mobile prepaid card is PSN#1 may be used. According to an embodiment of the present disclosure, since the ledger management server manages the PAN information of the mobile prepaid card of the user terminal 30 and the PAN information of the clone card stored in the tangible card to be the same, there is an advantage in that a separate synchronization procedure is not necessary although several payment media (i.e., the user terminal 30 and the tangible card 50) are used.

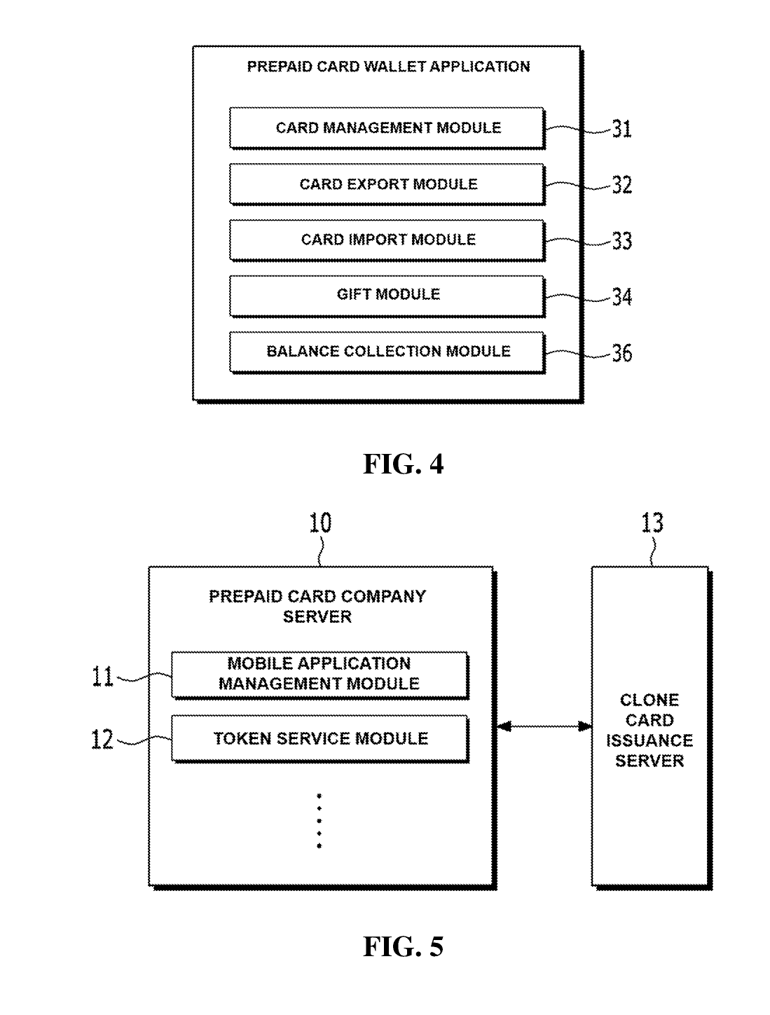

Hereinafter, the prepaid card wallet application of the user terminal and the prepaid card company server are described in detail with reference to FIGS. 4 and 5 in an exemplary embodiment of the present disclosure.

First, the prepaid card wallet application installed on the user terminal is described with reference to FIG. 4.

As shown in FIG. 4, the prepaid card wallet application according to an exemplary embodiment of the present disclosure may confirm issuance and balance of the basic card and the option card. The prepaid card wallet application may include: card management module 31 for processing an option card received from another user as a gift; a card export module 32 for requesting the prepaid card company server 10 issuance of a clone card of the stored mobile prepaid card 35 and transmitting the clone card 40 issued by the prepaid card company server 10 to a tangible card 50; a card import module 33 for generating a mobile prepaid card 35 from information on the clone card stored in the tangible card; a gift module 34 for giving the option card to another user as a gift; and a balance collection module 36 for adding the balance of the option card to the balance of the basic card.

The card management module 31 may process the basic card and the option card. The option card is a card to which a separate use amount is assigned within a charged amount of the basic card according to a selection received from the user terminal.

The card export module 32 may transfer the basic card or the option card to the tangible card 50, and the card import module 33 may read and receive information on the tangible card 50 onto the basic card or the option card, which are prepaid cards, i.e., read information on the tangible card 50 onto the user terminal 30. According to embodiments, the card export module 32 may transmit information on the mobile prepaid card and all the charged amount of the mobile prepaid card to the tangible card 50, and the card export module 32 may delete the information on the mobile prepaid card transferred to the tangible card 50 from the user terminal 30. When the information on the mobile prepaid card and some or all of the charged amount of the mobile prepaid card are copied to the tangible card 50, the prepaid card company server 10 may manage the clone card information copied to the tangible card 50 using a PAN the same as that of the mobile prepaid card linked to the user account. The mobile prepaid card may be stored in the user terminal 30 in the form of a token value, and the prepaid card company server 10 may have information on the token value mapped to the information on the tangible card of the mobile prepaid card.

If the token value stored in the user terminal 30 is exhausted, the clone card issuance server 13 may generate a new token value according to a predefined algorithm and issue it to the user terminal 30.

The prepaid card wallet application may be a mobile application executed in a smart phone, a smart card, a smart pad, a smart watch or the like. The user terminal 30 may include various computing devices in which the prepaid card wallet application can be installed and executed. The user terminal 30 may be a certain device provided with at least one processor and may include a camera, a portable device, a mobile terminal, a communication terminal, a portable communication terminal, a portable mobile terminal and the like. For example, the user terminal 30 includes a digital camera, a smart phone, a cellular phone, a game console, a television (TV) set, a display device, a vehicle head unit, a notebook computer, a laptop computer, a tablet computer, a personal media player (PMP), a personal digital assistant (PDA), a navigation device and a bank ATM. In addition, in the exemplary embodiments of the present disclosure, the user terminal 30 may be a wearable device (e.g., a watch-type device, a glasses-type device, a cloth-type device, etc.).

Next, the prepaid card company server 10 according to an exemplary embodiment of the present disclosure is described with reference to FIG. 5.

As schematically shown in FIG. 5, the prepaid card company server 10 according to an exemplary embodiment of the present disclosure may include: a mobile application management module 11 for managing mobile applications (e.g., the prepaid card wallet application) respectively stored in a plurality of user terminals; and a token service module 12 for mapping a primary account number (PAN) corresponding to the mobile prepaid card 35 included in the token of a clone card issuance request and registering the clone card in the mapped primary account number (PAN).

In addition, the prepaid card company server 10 according to an exemplary embodiment of the present disclosure is connected to the clone card issuance server 13, which issues clone cards, and responds to the clone card issuance request. Although the clone card issuance server 13 is described to be independent from of the prepaid card company server 10 in an exemplary embodiment of the present disclosure, the clone card issuance server 13 may be included in the prepaid card company server 10 as one module as needed.

In addition, the prepaid card company server 10 of the present disclosure may further include various modules needed for providing prepaid card service.

First, the mobile application management module 11 provides a prepaid card wallet application that can be used in the user terminal 30. Then, the mobile application management module 11 establishes a secure channel for lifecycle management of the prepaid card wallet application, a mediation function with other services, and data exchange with a mobile application provided in the user terminal.

When a tangible card and the user terminal are connected in a short distance wireless communication method to issue a clone card, the prepaid card wallet application provided by the mobile application management module 11 transfers a clone card issuance request to the prepaid card company server 10. In this embodiment, tagging the user terminal with the tangible card may be accomplished by transmitting and receiving application protocol data units (APDUs) through an NFC RW mode.

In an exemplary embodiment of the present disclosure, the prepaid card company server 10 may be a host card emulation (HCE) based service server, and in this case, it may be implemented to store and manage personal information such as card information in a cloud secure element (SE) (or a cloud platform), not in a hardware SE such as a universal integrated circuit card (UICC) or an embedded SE. To solve the security problem in implementing the HCE technique, a tokenization technique is employed in this embodiment, and exposure of card information or personal information in the transaction process can be prevented by issuing a token corresponding to important information such as the card information.

Accordingly, in this embodiment, all the data exchanged between the prepaid card company server 10 and the user terminal are implemented in the form of a token.

In this embodiment, the token service module 12 performs issuance and storage of token information so that the prepaid card company server 10 of this embodiment may accomplish the function of a cloud SE.

In this embodiment, the token service module 12 searches for a primary account number (PAN) mapped to a target mobile prepaid card 35 included in the tokenized clone card issuance request that the mobile application management module 11 has received from the user terminal 30. The token service module 12 may map the received token information and the PAN information, and store them in the form of a table. As another embodiment, the token service module 12 may be implemented to store the token and PAN information using a certain algorithm capable of deriving a relation between the token information and the PAN information or to store only a path to the mapping table of the token value and the PAN value.

In addition, if the clone card issuance server 13 issues a clone card which shares the primary account number (PAN), the token service module 12 registers the corresponding clone card in the primary account number (PAN). The token service module 12 may register the clone card to have a unique identification value (PSN information) different from that of a previously registered mobile prepaid card 35.

In addition, if registration of the clone card is completed, the token service module 12 generates and stores a token including information on the clone card (hereinafter, referred to as a clone card information token) in the secure element (SE) of the clone card. The clone card information token may be the same as or different from the token of a targeting mobile prepaid card 35. As the card information is stored and managed in the secure element (SE), risk of forgery can be minimized, and various services can be provided.

In addition, the clone card issuance server 13 issues a clone card corresponding to the requested mobile prepaid card 35, registers the issued clone card in the primary account number (PAN) through the token service module 12, and transmits the clone card information token generated by the token service module 12 to the user terminal 30. When the clone card information token is transmitted to the user terminal 30, the card export module 32 of the prepaid card wallet application is executed in the user terminal 30, the tangible card 50 and the user terminal 30 are connected with each other using a short distance wireless communication method such as NFC or the like, the clone card of the mobile prepaid card 35 is exported to the tangible card, and therefore the user gets a tangible card 50 linked to the targeting mobile prepaid card 35.

In an embodiment of the present disclosure, the token service module 12 of the prepaid card company server 10 and the clone card issuance server 13 are closely connected to each other and configure a so-called clone card issuance system for issuing a clone card of a mobile prepaid card.

When a clone card 40 of a mobile prepaid card 35 is issued in an embodiment of the present disclosure, the user terminal 30 functions as a medium between the prepaid card company server and the tangible card, and allows a user to request issuance of a clone card.

In addition, the prepaid card company server 10 according to an exemplary embodiment of the present disclosure may further include a ledger management server for performing management of a charged amount and a balance. The ledger management server manages a charged amount and a balance after a transaction, in correspondence to an account, registered when the user terminal 30 subscribes a service, or PAN information. For example, when a transaction request is received from the merchant terminal 60, the ledger management server confirms a balance corresponding to the PAN information included in the transaction request and approves payment if the payment amount is within the balance. The transaction request includes a token value, and the ledger management server may obtain PAN information corresponding to the token value through the token service module 12 and perform a payment approval process.

In addition, the prepaid card company server 10 receives a service subscription application from a user connected through the user terminal 30. At the same time as the service subscription, the prepaid card company server 10 opens a user account assigned to each user and provides the user account to the user terminal 30. The user account refers to a personal account stored in a user database of the prepaid card company server 10 in the form of an identifier such as a user ID. The prepaid card company server 10 may manage a ledger in the ledger management server in association with the user account or the card information. For example, the user account may be stored to be distinguished by the user ID or the like. For example, when the user account is User_ID_1 and possesses one basic card and two option cards, basic card information, first option card information and second option card information may be mapped and stored for User_ID_1. The card information may respectively include PAN information and a unique identification value (PSN number).

Although it is described in this embodiment that the prepaid card company server 10 includes two modules as described above, it is not limited thereto, and the prepaid card company server 10 may further include additional modules for various functions desired to be accomplished.

The clone card 40 issued according to the method of issuing a clone card of a mobile prepaid card according to an exemplary embodiment of the present disclosure is a card in which information on the mobile prepaid card 35 stored in the user terminal 30 is copied as is, and a user may make a payment at a franchise store (merchant's store) through an offline payment while possessing only the clone card 40, without possessing the user terminal 30 in which the mobile prepaid card 35 is stored.

Since a prepaid card that can be used even in a mobile, online or offline environment can be easily issued and used, convenience is enhanced from the viewpoint of a user, and generation of profits can be maximized through diversification of the service from the viewpoint of a prepaid card company.

Although it is described above focusing on the process of storing the clone card 40 in a tangible card using the mobile prepaid card 35, contrarily, the mobile prepaid card may be generated in the user terminal 330 using a clone card stored in the tangible card.

That is, after executing the card import module 33 of the prepaid card wallet application stored in the user terminal 30 and connecting the tangible card 50 storing the clone card 40 to the user terminal 30 using a short distance communication method, information on the clone card 40 is read from the tangible card 50, and a mobile prepaid card can be generated in the prepaid card wallet application.

In an embodiment of the present disclosure, the clone card 40 may be generated with regard to the basic card or an option card included in the mobile prepaid cards.

Although it is stated and described above that a mobile prepaid card is stored in the user terminal 30 and, at the same time, there also exists a clone card 40, which is a tangible card having information on the mobile prepaid card (i.e., the clone card 40 is a replicated card or a child card of the mobile prepaid card 35), according to embodiments, the mobile prepaid card 35 may be deleted from the user terminal 30 when a clone card 40 corresponding to the mobile prepaid card 35 is stored in the tangible card 50, and contrarily, all the information on the tangible card may be deleted from the tangible card 50 when a clone card 40 corresponding to the mobile prepaid card is generated using the tangible card 50. In this case, it may be configured to link the primary account number only to the clone card 40 when the clone card 40 is issued, without need of sharing the primary account number with the mobile prepaid card 35.

In an embodiment of the present disclosure, the mobile prepaid card is an HCE mobile card, which is a software SE configuring a cloud SE using the prepaid card company server 10. As an embodiment, the HCE mobile card may be stored in the user terminal 30 in the form of a token value.

In this embodiment, the tangible card 50 in which a clone card is stored may be a multi-card which can contain information on a plurality of prepaid cards and may include a function of short distance wireless communication with the user terminal 30. The tangible card 50 includes a magnetic stripe card, an IC card, and a combination card.

The tangible card 50 may be purchased online or offline in response to a request of a user without a face-to-face confirmation procedure. For example, if a user requests purchase of a tangible card through the wallet application, the user may receive the tangible card 50 by mail delivery through a predetermined procedure after the prepaid card company server 10 receives the request. As another embodiment, the tangible card 50 may be sold at a retail store. The tangible card may be sold in an empty state without a charged amount or may be sold in a form of charged with a predetermined amount.

A user having the mobile prepaid card 35 or the clone card 40 may make a payment for purchasing a product or a service at a store of merchant using the prepaid card service through the user terminal 30 or the tangible card 50. The user terminal 30 may transmit tokenized card information to the merchant terminal 60 installed in the store of merchant through short distance wireless communication (e.g., NFC), or a bar code, a quick response (QR) code or the like including a token value of a mobile prepaid card displayed on the screen of the user terminal 30 may be scanned through a code reader provided in the merchant terminal 60, and information on the mobile prepaid card may be transmitted to the acquirer company.

In the embodiment described above, for security purpose, the prepaid card company server 10 may tokenize at least one piece of information among the mobile prepaid card information, the payment information and the user identification information, and provide the user terminal 30 with the tokenized information so that a request of approval can be made using the token. As an embodiment, the token value of the card information may be a token value issued to the user terminal 30 in real-time or stored in the user terminal 30 in advance according to predefined criteria.

The merchant terminal 60 may generate payment request information by encoding the token value and the payment information (e.g., a payment amount, a payment date and time and the like) received from the user terminal 30. The merchant terminal 60 transmits the encoded payment request information to the prepaid card company server 10. The prepaid card company server 10 decodes the payment request information and extracts the payment information, and extracts the card information from the token value (detokenization). The ledger management server of the prepaid card company server 10 determines whether the requested payment is acceptable by confirming the ledger of the card information and transmits a result of payment approval to the merchant terminal 60. The ledger management server stores a balance after subtracting the payment amount.

Since the prepaid card company server 10 manages the card information and the ledger in the present disclosure, the card information and information on the amount do not need to be stored in the user terminal 30, and since other terminals excluding the prepaid card company server do not know the card information, there is an effect of preventing forgery, hacking or theft in the payment process.

The configuration and operation of the prepaid card wallet application will be described below in more detail through an example executing the prepaid card wallet application.

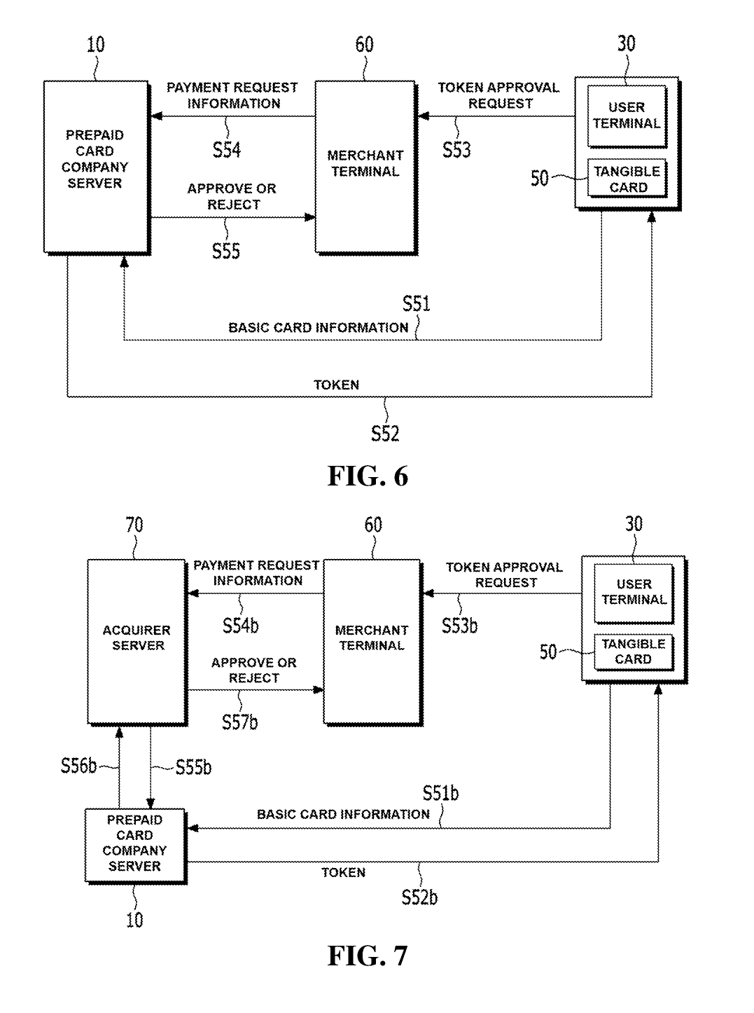

FIGS. 6 and 7 are diagrams schematically illustrating the process of making a payment using a user terminal in which a mobile prepaid card is stored or a tangible card in which a clone card is stored.

First, referring to FIG. 6, the user of the user terminal 30 purchases a product or a service at a store of merchant and presents a mobile prepaid card of the user terminal 30 or a clone card as a payment means. As an embodiment, the user terminal 30 provides information on the mobile prepaid card to the prepaid card company server 10 (step S51), and the prepaid card company server 10 issues a token corresponding to the mobile prepaid card information (step S52).

As another embodiment, the token issued and transferred at step S52 may be a token issued and stored in the user terminal 30 or the tangible card 50 in advance. At this point, the user terminal 30 makes a payment through the merchant terminal 60 without communication (steps S51 and S52) with the prepaid card company server 10.

The token issued at step S52 or the token stored in the user terminal 30 in advance is provided to the merchant terminal 60 to be approved (step S53), and the merchant terminal 60 confirms approval by transmitting a corresponding token and information on the payment amount to the prepaid card company server 10 that has issued the token (step S54). As an embodiment, the user terminal 30 generates encoded payment request information by encoding a token value corresponding to the card information and the payment request information (e.g., including a payment amount, a franchise store, a payment date and time, etc.). The user terminal 30 may generate the encoded payment request information using a predetermined encoding algorithm. The user terminal 30 may transmit the encoded payment request information to the prepaid card company server 10 through the merchant terminal 60.

As another embodiment, the merchant terminal 60 may generate the encoded payment request information using the token value and the payment request information received from the user terminal 30.

The prepaid card company server 10 may receive the encoded payment request information and acquire the token value and the payment request information by decoding the encoded payment request information. The prepaid card company server 10 confirms whether the balance of the user account linked to the mobile prepaid card of a corresponding token is larger than the payment amount through the ledger management server.

At this point, the prepaid card company server 10 determines whether or not to approve depending on a result of confirming whether the token is normal and whether the amount charged in the user account is larger than the payment amount and notifies a result of the approval to the merchant terminal 60 (step S55).

When a payment is made using the mobile prepaid card of the prepaid card wallet application of the user terminal 30, authentication of a password, fingerprint recognition or the like may be performed for identity authentication. That is, it may be set to perform the identity authentication by inputting a password or a fingerprint while executing the prepaid card wallet application of the user terminal 30.

The identity authentication like this is for preventing theft of a mobile prepaid card even when the user terminal 30 is lost, and more diverse authentication means may be included for security purpose.

If the user terminal 30 makes a mobile payment using a HCE method like this, there is an effect of enhancing security when a mobile payment is made since there is no worry of exposing card information through the user terminal 30 and the merchant terminal 60.

Next, a process of making a payment, when an acquirer company server 70 is further included in the embodiment of the payment process described with reference FIG. 6, will be described with reference FIG. 7.

The user of the user terminal 30 purchases a product or a service at a store of merchant and presents a mobile prepaid card 35 of the user terminal 30 or a clone card of a tangible card 50 as a payment means, and at this point, the user terminal 30 provides information on the mobile prepaid card to the prepaid card company server 10 (step S51b), and the prepaid card company server 10 issues a token corresponding to the mobile prepaid card information (step S52b).

Steps S51b and S52b may be omitted if a token issued in advance by the prepaid card company server 10 is stored in the user terminal 30, and in this case, the token stored in the user terminal 30 may be provided to the merchant terminal 60 to be approved.

The token issued at step S52b or the token stored in the user terminal 30 in advance is provided to the merchant terminal 60 to be approved (step S53b), and approval request information is provided to the acquirer company server 70, together with information on the price of the product or the service to be purchased, to be approved (step S54b). As described above, the payment request information may be generated as encoded information together with the token value and provided to the acquirer company server 70 and the prepaid card company server 10. The acquirer company server 70 confirms approval (step S56b) by transmitting a corresponding token and information on the payment amount to the prepaid card company server 10 (step S55b), and the prepaid card company server 10 confirms whether the balance of the user account linked to the mobile prepaid card 35 of a corresponding token is larger than the payment amount.

At this point, the prepaid card company server 10 determines whether or not to approve depending on a result of confirming whether the token is normal and whether the amount charged in the user account is larger than the payment amount (step S56b). The acquirer company server 70 notifies a result of the approval of the prepaid card company server 10 to the merchant terminal 60 (step S57b).

Although it is described above focusing on a case of using the mobile prepaid card 35 as a payment means by the user himself or herself who has joined the prepaid card company server 10, since a case of using a tangible card 50 including a clone card 40 also can be easily understood, detailed description thereof will be omitted.

Meanwhile, the user may use the prepaid card service using the mobile prepaid card 35 of the user terminal 30 and the clone card 40 of the tangible card 50.

For example, if a user issues a clone card for a mobile prepaid card having a use limit of 10,000 Korean Won (KRW), the clone card also has a use limit of 10,000 KRW.

At this point, the user may use the mobile prepaid card and the clone card in various environments such as mobile, online or offline environments, and first, if 2,000 KRW is primarily paid using the mobile prepaid card, the balance of the mobile prepaid card becomes 8,000 KRW, and since the ledger management server also has a balance of 8,000 KRW as 10,000-2,000=8,000, the balance of the clone card becomes also 8,000 KRW. Then, if the user pays 1,000 KRW secondarily using the clone card stored in the tangible card, the balance of the clone card becomes 7,000 KRW, and since the ledger management server also has a balance of 7,000 KRW as 8,000-1,000=7,000, the balance of the mobile prepaid card becomes also 7,000 KRW.

Meanwhile, an option card among the mobile prepaid cards is a card distinguished from the basic card and derived and generated from the basic card and includes an affiliate card and a non-affiliate card. The option card is linked to a user account the same as that of the basic card. However, the option card may be managed on the ledger management server to have a separate ledger according to different PAN information.

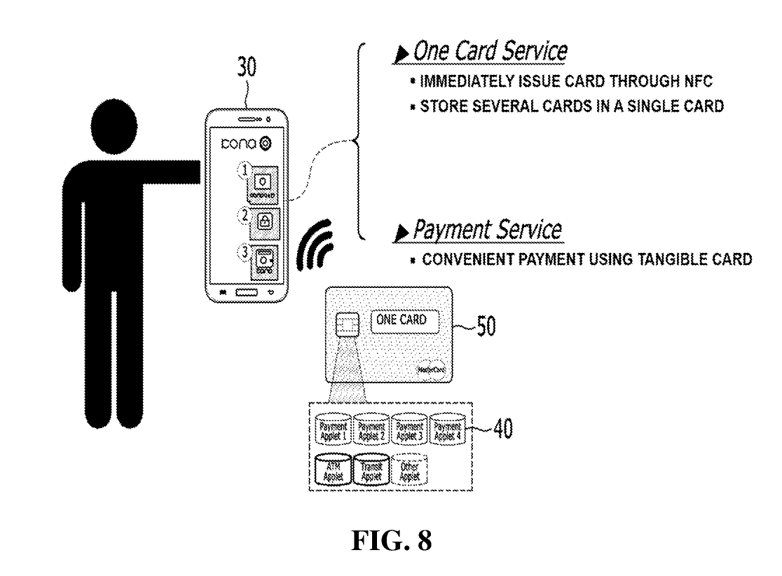

FIG. 8 is a conceptual diagram illustrating a user receiving a mobile prepaid card service using a user terminal and a tangible card.

As shown in FIG. 8, a user may store and use several prepaid cards, such as a basic card and an option card, using a prepaid card wallet application of the user terminal 30, and may use prepaid card service using a tangible card by issuing a clone card for a selected prepaid card and storing the clone card in the tangible card as needed.

Therefore, according to a system for issuing a clone card of a mobile prepaid card and a service system thereof according to an embodiment of the present disclosure, the clone card 40 is issued in the tangible card 50, and a service using one prepaid card may be provided in a mobile, online and offline environment.

Until present, a method of issuing a clone card for a mobile prepaid card according to an embodiment of the present disclosure has been described.

In addition, hereinafter, a method of issuing a mobile prepaid card and a mobile prepaid card service method according to an embodiment of the present invention will be described in detail.

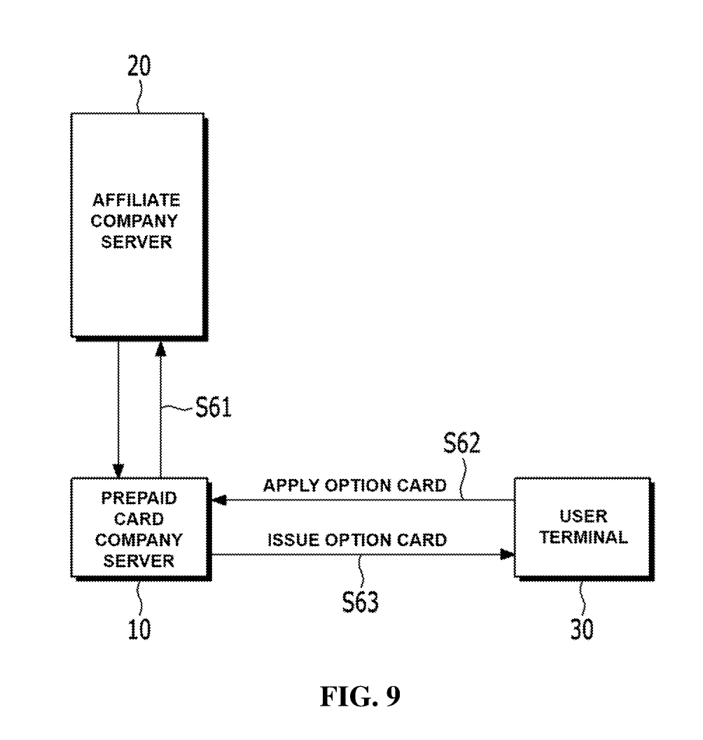

First, a process of issuing an affiliate card, which is one of option cards among mobile prepaid cards, will be described with reference to FIG. 9.

As shown in FIG. 9, the prepaid card company serer 10 establishes a partnership with the affiliate company server 20 and pays a specific amount to the affiliate company server 20 (step S61). If a request for issuing an option card having benefits of a specific affiliate company is received from the user terminal 30 (step S62), the prepaid card company serer 10 issues an option card indicating the partnership with the affiliate company server 20 (step S63).

First, the prepaid card company serer 10 establishes a partnership with the affiliate company server 20 and determines a scale of the partnership at step S61. For example, the prepaid card company serer 10 may determine a prepaid card payment amount that can be used at a corresponding affiliate company and issue an affiliate card, which is an option card, within the payment amount.

Although it is described above that an amount is paid to the affiliate company server 20 in advance, the option card may be issued without paying the amount in advance according to contract. For example, the prepaid card company serer 10 may periodically settle a used amount and periodically request purchase or settlement from the affiliate company server 20.

The affiliate card may be issued on the request of the user terminal 30 at step S62, and at this point, whether the affiliate card is registered or unregistered may be selected. As an embodiment, the user may select an expiry date of the basic card or the option card or arbitrarily input the expiry date within a predetermined range. As an embodiment, the prepaid card company server 10 or the user terminal 30 may provide an automatic notification function for a card which will be expired in less than a predetermined time. The user may change the expiry date of the mobile card or the tangible card through the prepaid card wallet application. For example, it may be implemented to extend the expiry date by three months within a range of five years from the issuance date.

The option card may be charged using an amount charged in the basic card. The user may issue or recharge the option card by limiting a use amount within the range of the amount charged in the basic card of the user account.

A feature of the affiliate card is that benefits such as point accumulation, coupons, discounts and the like can be provided while limiting the card to be used only at franchise stores of a corresponding affiliate company.

In response to a request for issuance of an affiliate card, the prepaid card company server 10 issues an affiliate card that can use an amount determined by the user to the user terminal with 30.

For example, if a specific specialty coffee shop establishes a partnership with a prepaid card company and advertises the coffee shop to users of the prepaid card company server 10, and the users request issuance of an affiliate card through the user terminal 30, the prepaid card company server 10 may issue the affiliate cards for the users to use.

Although it is described above that an affiliate company is a specific franchise store, an affiliate card that can be used in a specific business type or a specific region may be issued.

For example, an affiliate card for traditional markets or a Seoul city affiliate card that can be used in Seoul city can be regarded.

Although the amount charged in the user account is not subtracted immediately by the issuance of an affiliate card, it is advantageous to restrict an amount charged in the affiliate card not to be used through the basic card to secure stability of transactions.

Since the method of using the affiliate card is the same as the method of using the basic card described above, detailed description thereof is omitted.

The option card includes a non-affiliate card issued without regard to a separate affiliate company unlike the affiliate card described above, and examples of the non-affiliate card may include a promotion card, an event card or a coupon card issued by the prepaid card company server 10.

As the option card described above, a clone card 40 may be issued and stored in the tangible card 50 in the method as described above, and contrarily, the mobile prepaid card 35 may be generated from the information on the clone card 40 stored in the tangible card 50.

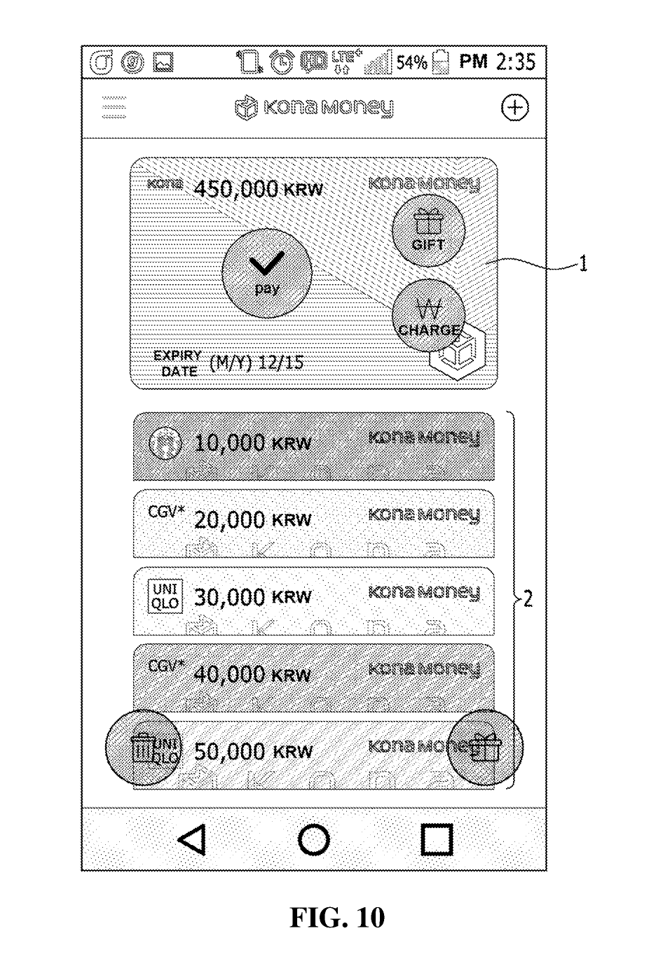

FIG. 10 is a diagram illustrating an example of a prepaid card wallet application screen of the user terminal 30.

When the card management module 31 (see FIG. 4) of the prepaid card wallet application is executed, prepaid cards issued using the prepaid card wallet application can be shown.

Referring to FIG. 10, for example, one of the basic card 1 and option cards 2 requested by the user to be issued are stored, and a charged amount is displayed on each of the basic card 1 and the option cards 2. In addition, the charged amount displayed on each of the basic card 1 and the option cards 2 is reduced as the user uses a corresponding card, and it may be set to display the balance by subtracting a used amount from the initially charged amount. The balance data is not stored in the user terminal 30, but managed through the ledger management server of the prepaid card company server 10.

FIG. 10 is a diagram illustrating an example in which the basic card 1 is charged with 450,000 KRW, and affiliate cards, which are option cards 2 respectively charged with 10,000 KRW, 20,000 KRW, 30,000 KRW, 40,000 KRW and 50,000 KRW from the top, are stored in the option cards 2.

When the affiliate cards, which are option cards 2, are issued, the user may determine and charge an amount, and the amount charged in each of the option cards 2 is subtracted from the amount charged in the basic card 1.

It may be understood such that the amount charged in the basic card 1 before generating the option cards 2 is 600,000 KRW, and the current amount of the basic card 1 is 450,000 KRW since 150,000 KRW, i.e., the charged amounts of the five option cards 2, are subtracted.

One of the features of the affiliate cards is that since the affiliate cards can be charged again in association with the basic card as needed by the user, and the business relationship between the affiliate companies and the user does not remain in a one-time relationship and can be continued, generation of recurring revenue can be expected from the viewpoint of affiliate companies.

Although it is described that the basic card and the affiliate card, i.e., option card, are mobile prepaid cards, the basic card and the affiliate cards, i.e., option cards, may be tangible cards. In addition, a non-affiliate card, which is another type of the option card, may also be a mobile cards or a tangible card.

The tangible card may be a device for storing card information in an external SE such as a card SE or a wearable device. For example, the tangible card includes an IC card, a combination card and an electronic device such as a smart watch.

The tangible card 40 may store information on the basic card and the option cards, which are mobile prepaid cards, through the card export module 32 of the user terminal 10 while being tagged with the user terminal 30 through short distance wireless communication. In addition, since the mobile prepaid cards stored in the user terminal 30 can be stored, edited and managed in various ways, an effect the same as storing, editing and managing the card information stored in the tangible card 40 in various ways can be obtained as the mobile prepaid cards stored, edited and managed like this are stored in the tangible card 40. For example, some or all of the mobile cards (e.g., option cards) possessed by the user terminal 30 may be transferred to the tangible card 40 while the tangible card 40 contacts (is tagged) with the user terminal 30. At this point, the mobile cards stored in the prepaid card wallet application of the user terminal 30 are deleted, and the card information is transferred to the tangible card 40. The prepaid card company server 10 may recognize as if the mobile prepaid cards stored in the user terminal 30 are deleted and a prepaid card is newly issued in the tangible card 40.

Contrarily, after the card import module 33 of the prepaid card wallet application is executed, the user terminal 30 may import some or all of the option cards stored in the tangible card 40 while contacting with the tangible card 40.

In an embodiment related to the card export module 32 and the card import module 33 described above, an amount to be transferred from an option card can be set. For example, only 10,000 KRW of a specific option card which is only used for a store of designated merchant such as a franchise store, out of 50,000 KRW charged in the specific merchant's store option card, may be exported to the tangible card. At this point, 40,000 KRW of the specific merchant's store option card remain in the mobile prepaid card of the user terminal 30, and a specific franchise store option card of 10,000 KRW is generated in the tangible card.

The prepaid card wallet application according to an embodiment of the present disclosure may further include an option card gift function.

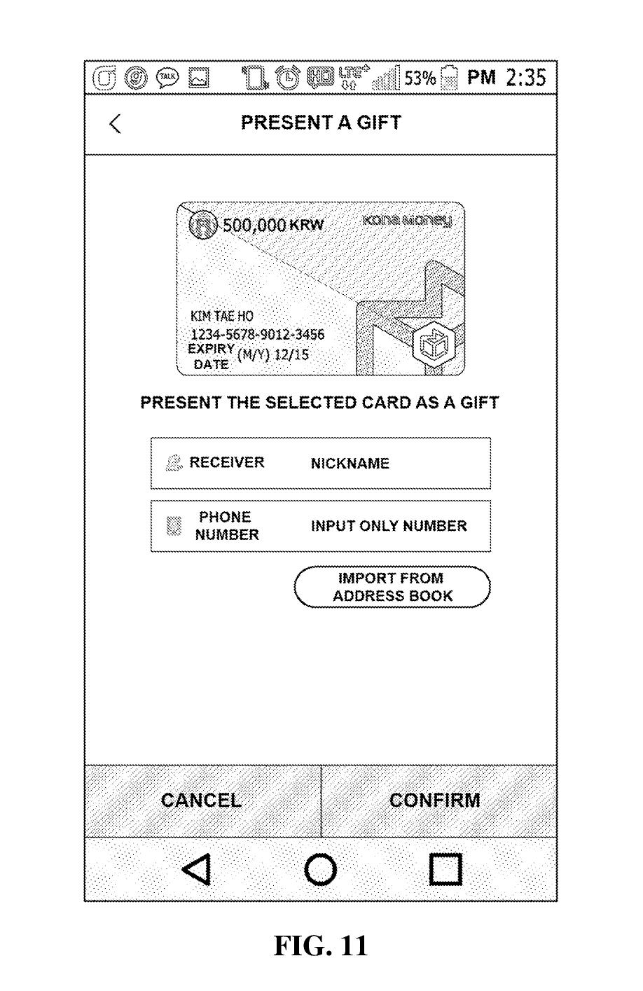

FIG. 11 is a diagram illustrating an example of executing the gift module 34 of the prepaid card wallet application of the user terminal 30 according to an exemplary embodiment of the present disclosure.

Referring to FIG. 11, the prepaid card wallet application executed in the user terminal 30 includes the gift module 34 for giving an option card to a prepaid card wallet application installed in another user terminal 30 as a gift.

The user executes the gift module 34 of the prepaid card wallet application, selects an option card to give, and transmits a gift card after specifying a user terminal 30 that will receive the option card as a gift by inputting a nickname or a phone number of a person receiving the gift. At this point, information on the nickname or the phone number of a person receiving the gift may be read from an address book managed in the user terminal 30.

If a prepaid card wallet application is not installed in another user terminal 30 that has received the option card as a gift, the another user terminal 30 that has received the option card as a gift joins the prepaid card company server 10 as a user, receives a basic card after installing the prepaid card wallet application and opening a user account, and links the option card received as a gift to the newly issued basic card.

When the gift function of the prepaid card wallet application of the user terminal 30 is used, some or all of the amount charged in the option card to be provided as a gift may be presented as a gift, and a plurality of user terminals 30 that will receive a gift can be specified.

As an embodiment, the prepaid card company server 10 may provide an automatic gift function to automatically present a gift to a specific person according to a specific condition. For example, the user of the user terminal 30 may set in advance a function of automatically presenting a predetermined card to a specific person when the balance is lower than a predetermined amount or at a specific time point.

As still another embodiment, when the user terminal 10 receiving the gift has an option card of the same type, a previously possessed option card and a presented option card may be integrated in one option card. This can be accomplished through the card management module 31.

For example, if integration of affiliate cards is performed when a second affiliate card of the same affiliate company charged with 5,000 KRW is presented as a gift while 10,000 KRW are charged in a first affiliate card possessed in advance, they can be re-generated as a third affiliate card charged with 15,000 KRW. At this point, when the function of integrating the first affiliate card and the second affiliate card is requested, the prepaid card company server 10 may use a method of deleting the first and second affiliate cards and generating a third affiliate card. Alternatively, the prepaid card company server 10 may use a method of deleting the second affiliate card and adding the amount of the second affiliate card to the amount of the first affiliate card.

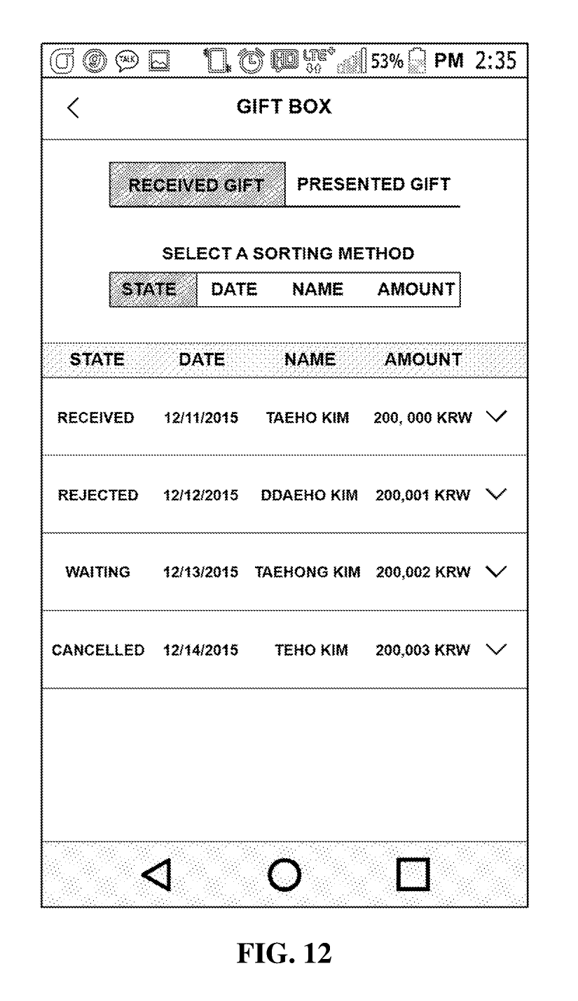

FIG. 12 is an exemplary embodiment of a gift box screen of the card management module 31 of the prepaid card wallet application, in which an option card gift presented from another user terminal may be rejected or accepted, and gifts may be categorized into received gifts and presented gifts and sorted on condition of a state, a date, a name and an amount.

An option card rejected by a user terminal that has received the option card as a gift is stored again in the prepaid card wallet application of the user terminal 30.

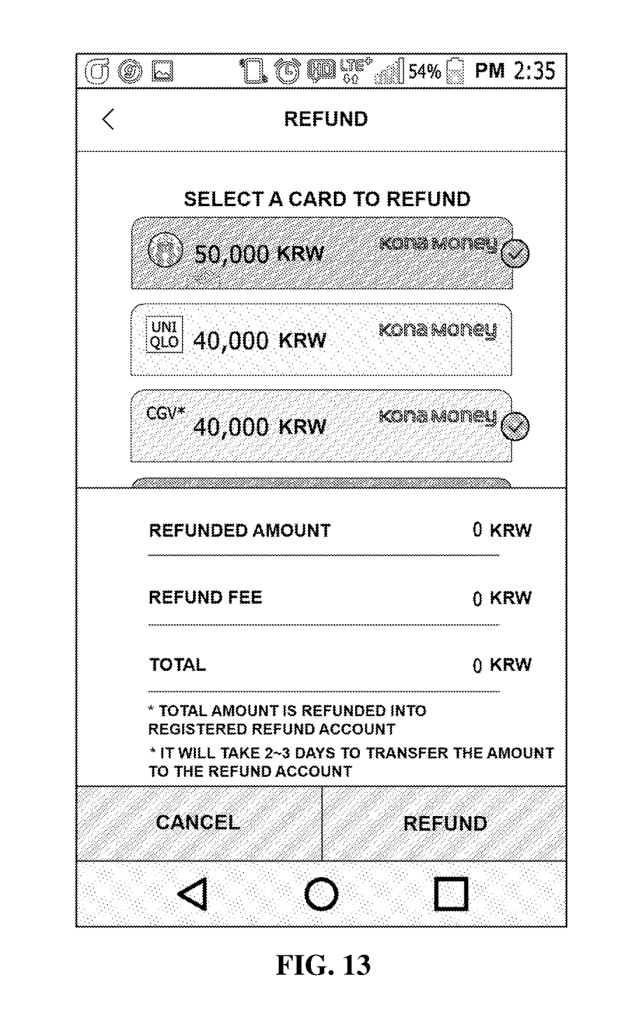

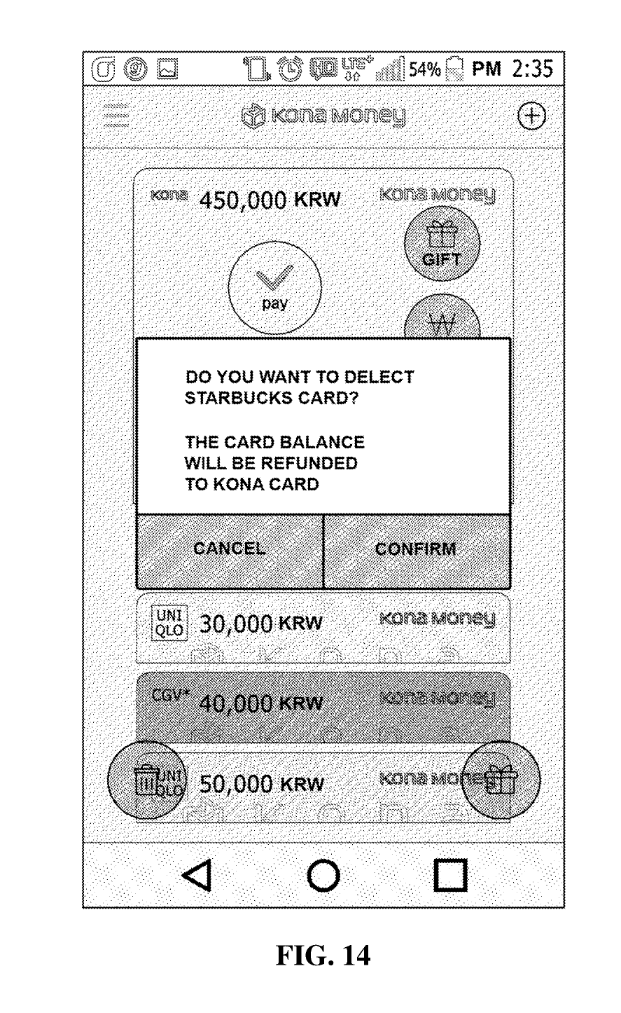

FIGS. 13 and 14 are diagrams respectively illustrating an example screen of a prepaid card wallet application for describing a method of processing a card balance using the present disclosure.

Referring to FIGS. 13 and 14 respectively, the present disclosure may execute the balance collection module 36 in the prepaid card wallet application and collect balances of option cards as a balance of the basic card. The option cards may or may not have a remaining balance.

In the case of an option card having a null balance, the option card is deleted from the prepaid card wallet application when the balance collection function is executed since it has nothing to do with balance processing, and this information is also provided to the prepaid card company server 10 to delete information on the issued option card from the user information managed in the prepaid card company server 10.

Like this, information on issuance and deletion of a card synchronizes information stored in the prepaid card company server 10 and information on the prepaid card wallet applications of the user terminal 30.

If an option card on which the balance collection function has been performed has a remaining balance, the balance of the option card is added to the balance of the basic card.

If there is a remaining balance after the balance collection function is performed on an option card, it is collected and managed as a balance of the basic card, and the balance collection may solve the troubled problem of handling the balance when only a small amount of money is left after using the option card and makes it possible to collect balances of option cards as a balance of the basic card when the balance of the basic card is insufficient when a payment is made using the basic card.

Although it is described above that the balance collection of the present disclosure accompanies deletion of option cards, it is also possible to request the prepaid card company server 10 collection of balances through the balance collection module 36 of the prepaid card wallet application of the user terminal 30 and to collect balances without deleting the option cards when the balance collection request is approved.

When the balance collection is requested, the balance collection may be approved according to predetermined criteria. For example, balance collection may be performed by regarding a remaining amount as a balance according to a criterion such as limiting the balance to a remaining amount less than 5% of the initially charged amount or by regarding a remaining amount as a balance if the current remaining amount is less than a predetermined amount.

In addition, balance collection may be performed when the balance of an option card is less than a minimum amount for providing an additional function.

It is apparent to those skilled in the art that the present invention is not limited to the embodiments described above and can be diversely changed or modified without departing from the scope and spirit of the present invention.

### INDUSTRIAL APPLICABILITY

In the present disclosure, a basic card and an option card can be freely issued and used within an amount charged in a user account of a user, and balances of option cards can be collected and used as a balance of the basic card as needed, and thus the inconvenience of handling the balances can be solved. Accordingly, the present disclosure can be utilized in various card service systems and also can be utilized for a user terminal using a mobile prepaid card service and a tangible card capable of communicating with the user terminal.

1-20. (canceled)

21. A card service system for providing a mobile card service, the system comprising:
a card company server for issuing a mobile card that can be used within a charged amount; and a card wallet application stored and executed in a storage space of a user terminal using the mobile card, and storing the mobile card, wherein
the mobile card includes:
a basic card linked to a user account stored in the card company server; and
at least one or more option cards distinguished from the basic card and provided with at least one or more additional functions.

22. The system according to claim 21, wherein the option card is assigned with a separate use amount within a charged amount of the basic card according to a selection received from the user terminal.

23. The system according to claim 21, wherein the card wallet application includes a balance collection module for adding charged amounts of the at least one or more option cards as a charged amount of the basic card.

24. The system according to claim 23, wherein the balance collection module is executed when a balance of the option card is lower than a preset ratio with respect to an initially charged amount or less than a minimum amount for providing the additional function, and adds the balance to the charged amount of the basic card.

25. The system according to claim 21, wherein the card wallet application includes a card export module for transferring the basic card or the option card to a tangible card.

26. The system according to claim 25, wherein the tangible card includes a storage device for storing card information in an external secure element (SE) such as a card SE or a wearable device.

27. The system according to claim 25, wherein the card wallet application further includes a card import module for reading information on the tangible card and transfer the tangible card information to the basic card or the option card, which are mobile cards.

28. The system according to claim 25, wherein the card export module transmits information on the mobile card and all of the charged amount of the mobile card to the tangible card, and deletes the information on the mobile card transferred from the user terminal.

29. The system according to claim 25, wherein
the card export module copies information on the mobile card and some or all of the charged amount of the mobile card to the tangible card, and
the card company server manages clone card information copied to the tangible card, using a primary account number (PAN) the same that of the mobile card linked to the user account.

30. The system according to claim 21, wherein the mobile card is stored in the user terminal in a form of a token value, and the card company server includes information on the token value mapped to information on the tangible card of the mobile card.

31. The system according to claim 30, further comprising a clone card issuance server for issuing a new token value generated according to a predefined algorithm to the user terminal when the token value stored in the user terminal is exhausted.

32. A clone card storage device for recording a clone card of a mobile card, the device including a secure element (SE) for storing information on the mobile card, which is stored in advance in a card wallet application stored and executed in a storage space of a user terminal, copied and transferred as clone card information in response to tagging the mobile card to the user terminal within a preset distance, wherein the clone card information is used as a payment means, independently of the mobile card.

33. The device according to claim 32, wherein the secure element includes a card SE or an SE mounted on a wearable device.

34. The device according to claim 32, wherein the clone card information includes card information of the mobile card and some or all of a charged amount of the mobile card.

35. The device according to claim 32, wherein the clone card information has primary account number (PAN) information the same as that of the mobile card and a different device identification number (PSN), wherein
the clone card information is managed by the card company server using the PAN information the same as that of the mobile card.

36. A clone card service method comprising the steps of:
a) transferring a request for issuing a clone card for a mobile card to a prepaid card company server, by a user terminal which stores the mobile card;
b) confirming account information for the mobile card, and requesting a clone card issuance server issuance of a clone card, by the card company server;
c) connecting to a card storage device through the user terminal, by the clone card issuance server; and
d) issuing a clone card corresponding to the mobile card to the card storage device, by the clone card issuance server.

37. The method according to claim 36, wherein the mobile card and the clone card have the same PAN information, and device identification numbers (PSNs) are different from each other.

38. The method according to claim 36, further comprising the step of e) registering the clone card in the account information, by the card company server, wherein
the step of registering the clone card includes the step of registering the clone card in the account information using PAN information the same as that of the mobile card.

39. The method according to claim 36, wherein the card company server includes a ledger management server for managing a balance of a card, wherein
when the ledger management server manages balances of the mobile card and the clone card, the ledger management server processes the mobile card and the clone card to have the same balance information according to the same PAN information.

40. The method according to claim 39, wherein the card company server processes to automatically synchronize the balances of the mobile card and the clone card according to update of the balance information.
